(19) United States
(12) Patent Application Publication
(10) Pub. No.: US 2026/0235818 A1
(43) Pub. Date: Aug. 13, 2026

(54) HIGH-DENSITY LOW-LOSS DETACHABLE OPTICAL CONNECTOR SYSTEM

(71) Applicant: MARVELL ASIA PTE LTD, Singapore (SG)

(72) Inventor: Kenneth Ling WONG, Saratoga, CA (US)

(21) Appl. No.: 19/298,124

(22) Filed: Aug. 12, 2025

Related U.S. Application Data
(60) Provisional application No. 63/757,250, filed on Feb. 11, 2025.

(51) Int. Cl. G02B 6/38

(52) U.S. Cl. CPC G02B 6/3882; G02B 6/3853

(57) ABSTRACT

A detachable connector system for optical communication comprises a connector comprising first alignment features and a micro-lens array arranged on the connector. The micro-lens array comprises second alignment features that are complementary to the first alignment features. A detachable connector system for optical communication comprises a first connector comprising holes and first alignment features and a first micro-lens array arranged on the first connector. The first micro-lens array comprises second alignment features that are complementary to the first alignment features. The system comprises a second connector comprising shafts configured to insert into the holes and a second micro-lens array arranged on the second connector.

### CROSS-REFERENCE TO RELATED APPLICATIONS

This application claims the benefit of U.S. Provisional Application No. 63/757,250 filed on Feb. 11, 2025. The entire disclosure of the application referenced above is incorporated herein by reference.

### FIELD

The present disclosure relates generally to optical communication systems and more particularly to a high-density low-loss detachable optical connector system for optical communication systems.

### BACKGROUND

The background description provided herein is for the purpose of generally presenting the context of the disclosure. Work of the presently named inventor, to the extent the work is described in this background section, as well as aspects of the description that may not otherwise qualify as prior art at the time of filing, are neither expressly nor impliedly admitted as prior art against the present disclosure.

Optical communication systems are widely used to transmit and receive data. For example, optical communication systems are used to transmit and receive data between data centers. Optical communication systems are also used to transmit and receive data between multiple computer systems within data centers. In optical communication systems, optical data is transmitted and received over communication channels comprising optical fibers.

### SUMMARY

A detachable connector system for optical communication comprises a connector comprising first alignment features and a micro-lens array arranged on the connector. The micro-lens array comprises second alignment features that are complementary to the first alignment features.

In additional features, the connector is made of glass.

In additional features, the connector is monolithic.

In additional features, the first alignment features have a semi-cylindrical shape. The second alignment features comprise grooves.

In additional features, the grooves are triangular and surround the first alignment features.

In additional features, the connector has a shape of a rectangular cuboid. The connector comprises two holes that extend along a length of the connector.

In additional features, an upper surface of the connector comprises a recess. The first alignment features are arranged on the recess. The first alignment features extend along the length of the connector.

In additional features, the connector comprises a body having a shape of a rectangular cuboid. The connector comprises two shafts that extend from the body along a length of the connector.

In additional features, an upper surface of the body comprises a recess. The first alignment features are arranged on the recess. The first alignment features extend along the length of the connector.

In still other features, a detachable connector system for optical communication comprises a first connector comprising holes and first alignment features and a first micro-lens array arranged on the first connector. The first micro-lens array comprises second alignment features that are complementary to the first alignment features. The system comprises a second connector comprising shafts configured to insert into the holes and a second micro-lens array arranged on the second connector.

In additional features, the first and second connectors are made of glass.

In additional features, the first and second connectors are monolithic.

In additional features, the second connector comprises third alignment features. The second micro-lens array comprises fourth alignment features that are complementary to the third alignment features.

In additional features, the second micro-lens array is aligned with the first micro-lens array by the first through fourth alignment features.

In additional features, the first and third alignment features have a semi-cylindrical shape. The second and fourth alignment features comprise grooves.

In additional features, the grooves are triangular. The grooves of the first micro-lens array surround the first alignment features of the first connector. The grooves of the second micro-lens array surround the third alignment features of the second connector.

In additional features, the first and second connectors have a shape of a rectangular cuboid. The holes extend along a length of the first connector. The shafts extend along a length of the second connector.

In additional features, an upper surface of the first connector comprises a first recess. The first alignment features are arranged on the first recess along the length of the first connector. An upper surface of the second connector comprises a second recess. The third alignment features are arranged on the second recess along the length of the second connector.

In additional features, the system further comprises a silicon photonics integrated circuit attached to the first connector and an optical fiber array unit attached to the second connector.

In still other features, a detachable connector system for optical communication comprises a first connector comprising holes and first alignment features and a first micro-lens array arranged on the first connector. The first micro-lens array comprises second alignment features that mate with the first alignment features. The system comprises a silicon photonics integrated circuit attached to the first connector, a second connector comprising shafts configured to insert into the holes and comprises third alignment features, and a second micro-lens array arranged on the second connector. The second micro-lens array comprises fourth alignment features that mate with the third alignment features. The system comprises an optical fiber array unit attached to the second connector.

In additional features, the first and second connectors are made of glass and are monolithic.

In additional features, the second micro-lens array is aligned with the first micro-lens array by the first through fourth alignment features.

In additional features, the first and third alignment features have a semi-cylindrical shape. The second and fourth alignment features comprise grooves.

In additional features, the grooves are triangular. The grooves of the first micro-lens array surround the first alignment features of the first connector. The grooves of the second micro-lens array surround the third alignment features of the second connector.

In additional features, the first and second connectors have a shape of a rectangular cuboid. The holes extend along a length of the first connector. The shafts extend along a length of the second connector.

In additional features, an upper surface of the first connector comprises a first recess. The first alignment features are arranged on the first recess along the length of the first connector. An upper surface of the second connector comprises a second recess. The third alignment features are arranged on the second recess along the length of the second connector.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF DRAWINGS

FIG. 1 is a block diagram of a silicon photonics integrated circuit (SPIC or PIC) comprising an optical transmitter and an optical receiver.

FIG. 2 is a perspective view of a glass receptacle of a detachable optical connector system that is attachable to the SPIC or PIC of FIG. 1.

FIG. 3 is a perspective view of a glass plug of the detachable optical connector system that is pluggable into the glass receptacle of FIG. 2.

FIG. 4 shows a top view of the glass receptacle of FIG. 2.

FIG. 5 shows a front view of the glass receptacle of FIG. 2.

FIG. 6 shows a top view of the glass plug of FIG. 3.

FIG. 7 shows a front view of the glass plug of FIG. 3.

FIGS. 8A-8C show a micro-lens array (MLA) attachable to the glass receptacle of FIG. 2.

FIGS. 9A-9C SHOW A MICRO-LENS ARRAY (MLA) ATTACHABLE TO THE GLASS PLUG of FIG. 3.

FIG. 10 shows the MLA of FIGS. 8A-8C and the glass receptacle of FIG. 2 with respective alignment features.

FIG. 11 shows the MLA of 9A-9C and the glass plug of FIG. 3 with respective alignment features.

FIG. 12 shows the MLA of FIGS. 8A-8C passively aligned and mounted to the glass receptacle of FIG. 2 using the respective alignment features.

FIG. 13 shows the MLA of 9A-9C passively aligned and mounted to the glass plug of FIG. 3 using the respective alignment features.

FIG. 14 shows the glass plug with the MLA (shown in FIG. 14) plugged into the glass receptacle with the MLA (shown in FIG. 13).

FIG. 15 is a cross-sectional view of a complete assembly of the detachable optical connector system comprising the glass plug, with attached MLA and an optical fiber array unit (FAU), that is plugged into the glass receptacle, with attached MLA and PIC.

FIGS. 16A and 16B show the optical fiber array unit (FAU) shown in FIG. 15.

FIG. 17A shows the MLA of FIGS. 8A-8C and the glass receptacle of FIG. 2 where the MLA can be passively aligned and mounted to the glass receptacle using respective alignment features.

FIG. 17B shows the glass plug of FIG. 3 and an MLA without alignment features that can be aligned and mounted to the glass plug using active alignment.

FIG. 18 shows a complete assembly of a detachable optical connector system comprising the glass plug, with attached MLA of FIG. 17B and an optical fiber array unit (FAU), that is plugged into the glass receptacle, with attached MLA and PIC.

In the drawings, reference numbers may be reused to identify similar and/or identical elements.

### DESCRIPTION

On-board optics (OBO) is a technology that integrates optical components directly onto a circuit board or within a package rather than using separate pluggable modules. This approach reduces power consumption, increases bandwidth, and enables higher channel densities in data centers. Co-packaged optics (CPO) is a technology that integrates optical and electrical components in the same package to improve performance, energy efficiency, and density in high-speed data transmission applications like data centers. CPO is a specific type of OBO where optical and electronic components are integrated within the same package, which further improves performance and efficiency.

A pluggable optical module is a hot-pluggable optical transceiver used in high-bandwidth optical data communication applications. An optical module typically comprises a silicon photonics integrated circuit (SPIC or PIC), a transimpedance amplifier (TIA), a driver, and a laser source. The optical module has an electrical interface on a side that connects to a network system and an optical interface on a side that connects to the outside world through a fiber optic cable. The optical module can plug into a socket on a front panel of the network system or into an on-board socket of the network system.

Each CPO/OBO system typically has many optical channels through which optical signals are transmitted to and received from the outside world. In comparison, pluggable optical modules typically have four to sixteen channels that use permanently attached optical fiber arrays. However, permanently attached optical fiber arrays are impractical since permanently attached optical fiber arrays are not reworkable. A single optical fiber failure that may occur during handling, transit, or assembly/test process step can reduce yield. Accordingly, detachable connectors are needed to improve manufacturing flexibility and yield.

The detachable connectors also need to have high-density form-factor and low-loss optical connection (with optical loss less than 2 dB). The detachable connector system should be able to survive multiple mate/de-mate (i.e., connect/disconnect) cycles and be mechanically robust and reliable over long-term. Further, the connector on the CPO/OBO side and the optical module side should be able to withstand solder reflow cycles. Accordingly, achieving high-density and low-loss (<2 dB) connections to CBO/CPO systems and optical modules is challenging.

The present disclosure solves the above problems by providing a high-density low-loss detachable optical connector system for optical communication systems. Specifically, the detachable optical connector system can be used to connect an optical fiber array unit (FAU) to a silicon photonics IC (called SPIC or PIC) of an optical module. An FAU is a compact assembly that aligns multiple optical fibers used to interface with PICs. The PIC comprises optical and electrical components of an optical transmitter and an optical receiver (collectively called an optical transceiver).

More specifically, the detachable optical connector system comprises a glass plug and a glass receptacle that have high-precision alignment features for mating and de-mating with each other. The alignment features on the glass plug and receptacle are tooled mechanical features. The glass plug with the alignment features is used on the optical fiber (FAU) side, and the glass receptable with the alignment features is used on the PIC side. The glass plug with the alignment features mates with the glass receptacle with the alignment features and connects (optically couples) an optical fiber array unit (FAU) to the PIC.

Throughout the present disclosure, glass is used as a non-limiting example of material used to manufacture the plug and receptacle. Instead, any other material with properties similar to glass can be used to manufacture the plug and receptacle. The material used to manufacture the plug and receptacle should be transparent and hard (i.e., have mechanical strength) like glass. The material should have optical, mechanical, and thermal properties of glass.

A micro-lens array (MLA) is an optical element comprising an array of multiple miniature lenses (microlenses) arranged in a pattern. MLAs are used to transmit and receive optical signals between the PIC and the FAU. The MLAs are mounted to the glass plug and receptacle comprising the alignment features. Mounting the MLAs on the glass plug and receptacle in perfect alignment with each other is critical to reduce optical loss. The MLAs comprise complementary alignment features for aligning the MLAs with each other when the MLAs are mounted to the glass plug and receptacle comprising the alignment features.

Specifically, each of the glass plug and receptacle comprises high-precision alignment features (e.g., half-rod like or semi-cylindrical projections) to align the respective MLA. As used herein, a semi-cylindrical shape means the shape of one half of a solid cylinder that is cut longitudinally into two identical halves. Each of the MLAs comprises a high-precision V-shaped groove that mates with the respective alignment feature on the glass plug and receptacle. Due to the alignment features on the MLAs and the glass plug and receptacle, the MLAs are perfectly aligned with each other when the MLAs are mounted to the glass plug and receptacle. The alignment is called passive alignment because the alignment features on the glass plug and receptacle and the grooves on the MLAs are tooled to mechanically align these components. In passive alignment, unlike in active alignment, no signals (optical, electrical, or both) are used for alignment.

Alternatively, a combination of passive and active alignment can be used. For example, the passive alignment can be used on the receptacle side as described above, and active alignment can be used on the plug side as follows. On the glass receptacle side, the glass receptacle and the MLA can comprise the alignment features and the groove for passive alignment described above. On the glass plug side, the glass plug may or may not have the alignment features. The MLA on the glass plug side does not have the groove. On the glass plug side, active alignment is used instead of passive alignment as follows.

Initially, the MLA without the groove is aligned to the FAU using a mirror as described below in detail. Upon alignment, the MLA is attached (e.g., glued) to the FAU. Subsequently, the glass plug is inserted into the glass receptable. The FAU, with the MLA attached thereto, is aligned with the MLA that is already attached to the glass receptacle. Upon alignment of the MLAs, the FAU with the MLA attached thereto is attached (e.g., glued) to the glass plug. Finally, the PIC is aligned with the assembly comprising the glass plug and receptacle with respective MLAs. Upon alignment, the PIC is attached (e.g., glued) to the glass receptacle. Thereafter, the glass plug and FAU sub-assembly is disconnected (removed, detached, or disengaged) from the glass receptacle. The glass plug and receptacle comprise epoxy reservoir features to facilitate the assembly (attachment) of the components described above.

The detachable optical connector system provides high-density optical interconnect with minimal loss. The detachable connector system eliminates the need for active alignment which is technically challenging and expensive. However, a combination of passive and active alignment can be used as described above. The detachable connector system also provides flexibility in attaching a PIC subassembly to an optical module/switch by using reliable solder reflow as follows.

In the detachable connector system, the PIC is attached to the glass receptacle with the MLA as described above. The FAU is attached to the glass plug instead of the PIC. Then, with no FAU attached to the PIC, the PIC and the glass receptacle with the MLA are soldered to a substrate. Unlike the FAU, the glass receptacle and the MLA can withstand the solder reflow. After the soldering, the glass plug with the FAU and MLA attached to the glass plug can be attached to (plugged into) the glass receptable with the MLA and the PIC attached to the glass receptacle. Thus, in the detachable connector system, the FAU need not be attached to the PIC and need not undergo the soldering process. Absence of fiber ribbon appendages (the FAU) during optical module/switch attachment (reflow soldering) significantly improves yield.

The detachable optical connector system also allows modular testing of each PIC subassembly and other components such as light engines before attaching the components to an optical module/switch. For example, a light engine can be attached to the glass receptacle with the MLA. The light engine attached to the glass receptable can then be soldered onto a substrate and tested. The glass plug with the FAU and MLA attached thereto can be inserted into the glass receptacle if and as needed. After thus testing multiple light engines, the light engines can be assembled into an optical module/switch. These and other features of the detachable optical connector system of the present disclosure are described below in detail.

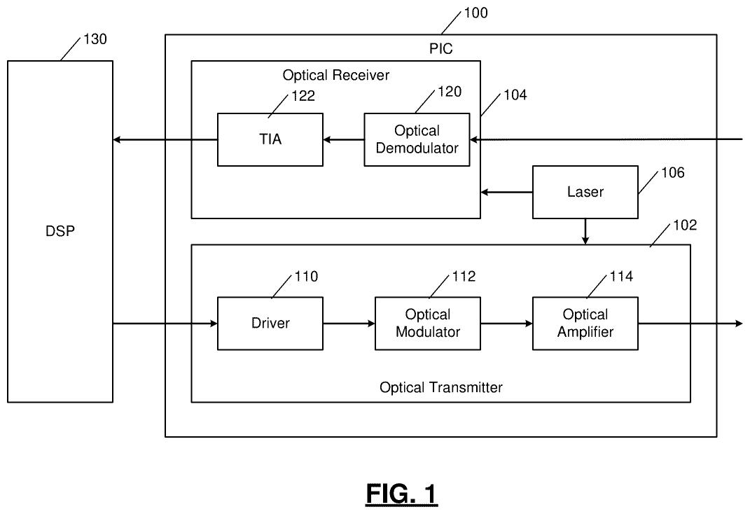

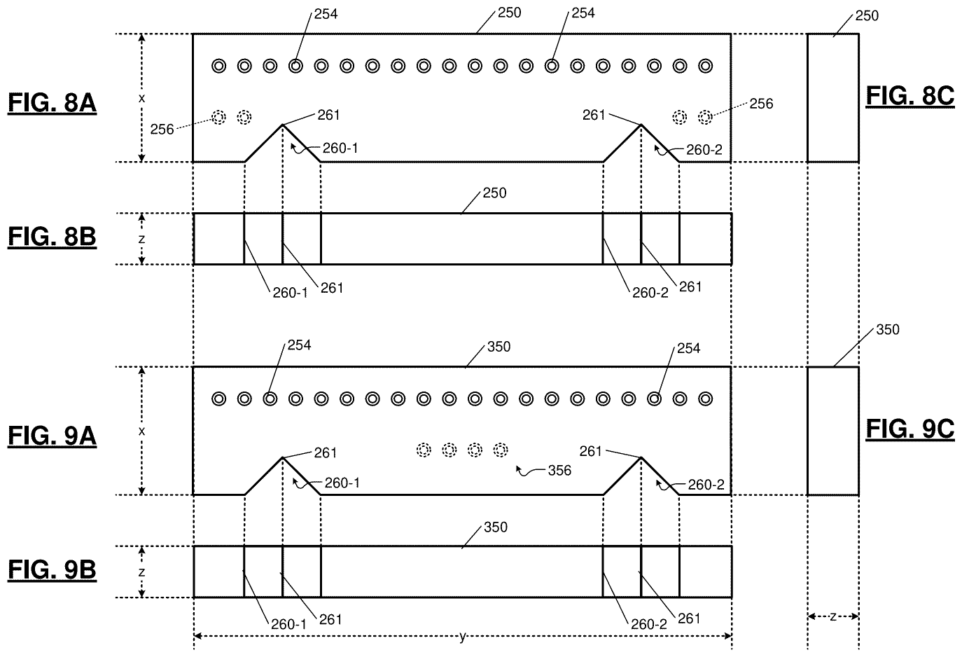

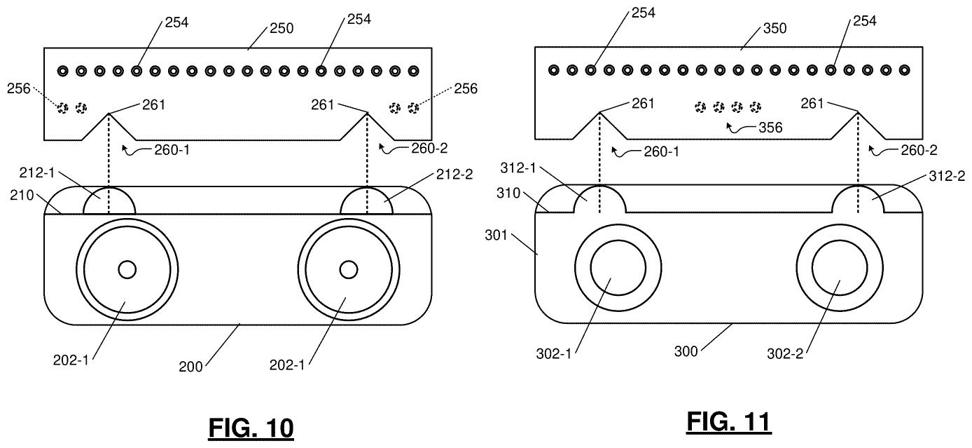

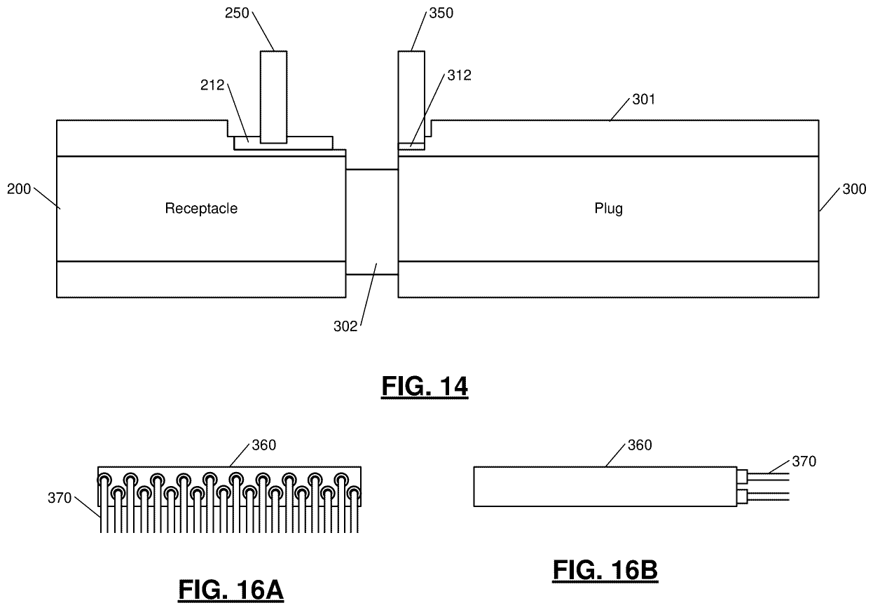

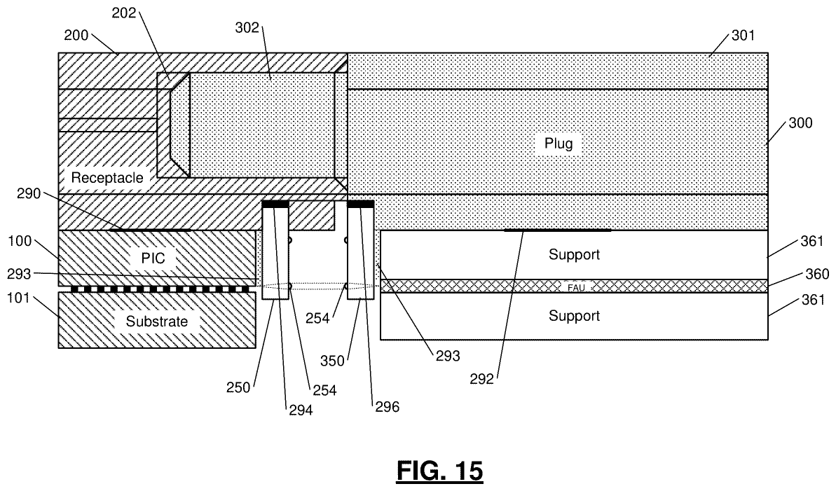

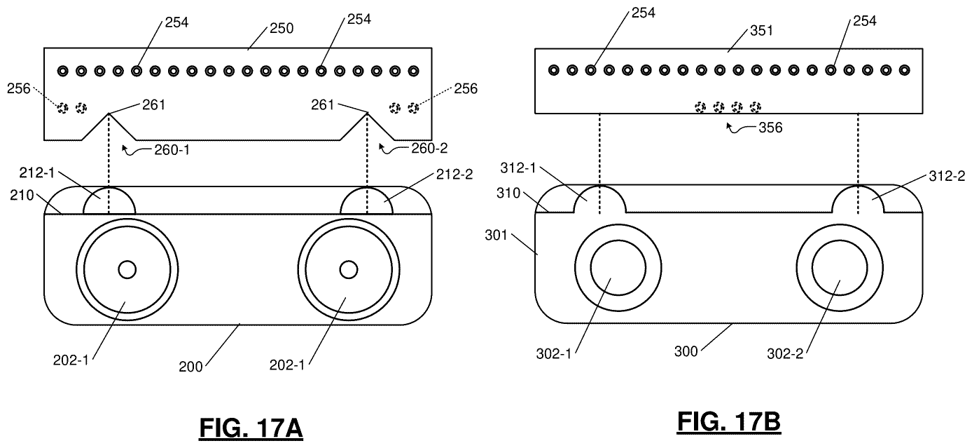

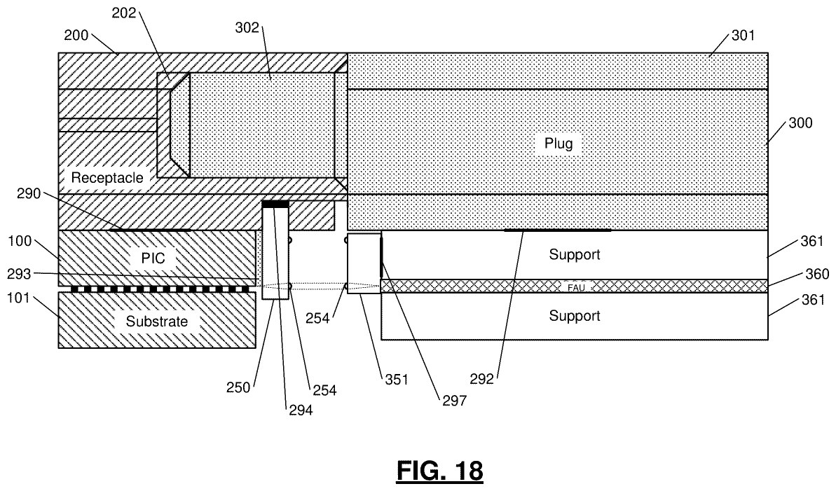

The present disclosure is organized as follows. An example of a silicon photonics integrated circuit (SPIC or PIC) is shown and described with reference to FIG. 1. Various components of the detachable optical connector system that use passive alignment are shown and described with reference to FIGS. 2-16B. Specifically, FIGS. 2-7 show glass receptacle and plug with passive alignment features. FIGS. 8A-8C and 9A-9C show MLAs with passive alignment features. FIGS. 10-13 show the glass receptacle and plug with the respective MLAs aligned and mounted to the glass receptacle and plug using respective passive alignment features. FIG. 14 shows the glass plug inserted into the glass receptacle. FIG. 15 shows the complete assembly comprising the glass receptacle with the MLA and the PIC, and the glass plug with the MLA and the optical fiber array unit (FAU) shown in FIGS. 16A and 16B. FIGS. 17A-18 show various components of the detachable optical connector system that use passive alignment on the receptacle side and active alignment on the plug side.

### Silicon Photonics Integrated Circuit (SPIC or PIC)

FIG. 1 shows an example of a silicon photonics integrated circuit (called SPIC or PIC) 100. The PIC 100 can be used in any optical module/switch to transmit and receive optical data in an optical communication system. The PIC 100 can transmit and receive optical data over an optical communication channel (e.g., optical fiber) though an optical fiber array unit (FAU) 360 shown in FIGS. 16A and 16B.

The PIC 100 comprises an optical transmitter 102, an optical receiver 104, and a laser 106. The optical transmitter 102 comprises a driver 110, an optical modulator 112, and an optical amplifier 114. The optical receiver 104 comprises an optical demodulator 120 and a transimpedance amplifier (TIA) 122. A digital signal processor (DSP) 130 is coupled to the PIC 100 (e.g., to the optical transmitter 102 and the optical receiver 104). The laser 106 outputs laser light to the optical modulator 112 and the optical demodulator 120.

In the optical transmitter 102, the optical modulator 112 receives data to be transmitted from the PIC 100. For example, the optical modulator 112 receives the data from the DSP 130. The driver 110 drives the optical modulator 112. The optical modulator 112 modulates the laser light with the data and outputs a modulated optical signal to the optical amplifier 114. The optical amplifier 114 amplifies the modulated optical signal. The optical transmitter 102 transmits the amplified modulated optical signal over the optical communication channel via the FAU 360.

In the optical receiver 104, the optical demodulator 120 receives an optical signal received over the optical communication channel via the FAU 360. The optical demodulator 120 demodulates the received optical signal and extracts data from the received optical signal. The TIA 122 amplifies the data and outputs the data to the DSP 130 for further processing.

The PIC 100 is connected to the optical communication channel using a detachable optical connector system of the present disclosure. The detachable connector system comprises a glass receptacle, a glass plug, and respective micro-lens arrays (MLAs), which is described below in detail.

### Glass Receptable and Plug

FIG. 2 shows a perspective view of a glass receptacle 200 attachable to the PIC 100. While various features of the glass receptacle 200 are described below, the glass receptacle 200 is a single, unitary machined (tooled) piece of glass. The glass receptacle 200 is monolithic. The glass receptacle 200 is generally of the shape of a rectangular cuboid. The glass receptacle 200 is solid (not hollow) except for the holes 202 in the glass receptacle 200 (described below).

The glass receptacle 200 has six surfaces: an upper and a lower surface, two sides (side surfaces), and a front and a back surface. The lower surface, the two side surfaces, and the back surface are flat. As shown in FIG. 4, the glass receptacle 200 has a length “a,” which is a distance between the front and the back surfaces; a width “b,” which is a distance between the two side surfaces; and a height “c,” which is a distance between the lower and the upper surfaces. c<a<b.

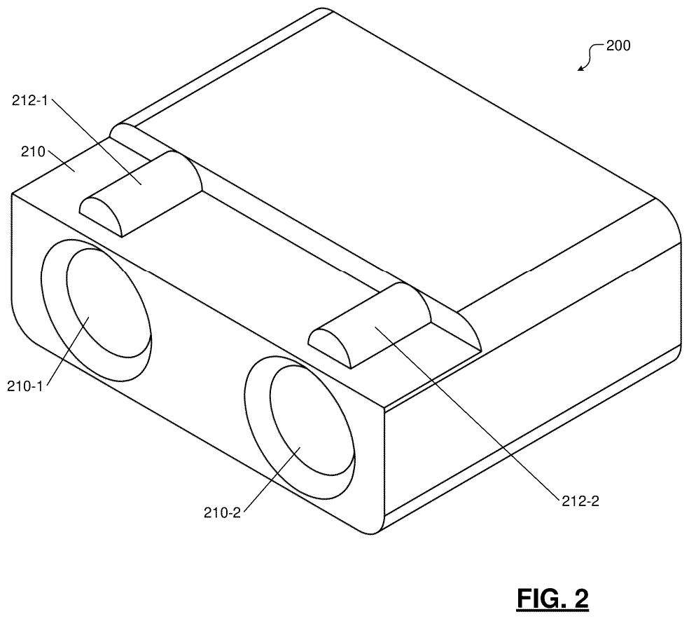

The front surface of the glass receptacle 200 comprises two holes 202-1, 202-2 (collectively called the holes 202 and individually called the hole 202). The holes 202 are cylindrical. The holes 202 receive shafts (shown at 302 in FIG. 3) of a glass plug 300 (shown and described below with reference to FIG. 3). The holes 202 do not extend through the back surface of the glass receptacle 200. Rather, the holes 202 extend through the front surface about halfway into the body of the glass receptacle 200. The holes 202 extend along the length “a” of the glass receptacle 200.

A length of the holes 202 is greater than a length of the shafts (shown at 302 in FIG. 3) of the glass plug 300. A diameter of the holes 202 is equal to a diameter of the shafts 302 of the glass plug 300. The openings of the holes 202 at the front surface of the glass receptacle 200 are tapered (chamfered) radially inwards. Due to the tapered (chamfered) openings of the holes 202, the shafts 302 of the glass plug 300 slide and insert smoothly into the holes 202 of the glass receptacle 200 when the glass plug 300 is plugged into the glass receptacle 200. When the shafts 302 of the glass plug 300 are inserted into the holes 202 of the glass receptacle 200, the glass plug 300 and the glass receptacle 200 are aligned with each other. Accordingly, the shafts 302 of the glass plug 300 and the holes 202 of the glass receptacle 200 can also be called alignment features of the glass plug 300 and the glass receptacle 200.

The top surface of the glass receptacle 200 is flat except for a recess and bumps in the recess that are machined (tooled) in the glass receptacle 200 as described below. The top surface of the glass receptacle 200 comprises a recess (or a shelf) 210. The recess 210 is generally rectangular. The recess 210 extends along the length “a” of the glass receptacle 200. The recess 210 extends between the two side surfaces of the glass receptacle 200. The recess 210 extends for less than half the length “a” of the glass receptacle 200. A length of the recess 210 measured along the length “a” of the glass receptacle 200 is less than the length of the holes 202. A width of the recess 210 is equal to the width “b” of the glass receptacle 200. A height of the recess 210 is a distance between a lower surface of the recess 210 and the upper surface of the glass receptacle 200 measured along the height “c” of the glass receptacle 200. The height of the recess 210 is less than the diameter of the holes 202.

The top surface of the glass receptacle 200 comprises two half-rod-like bumps 212-1, 212-2 (collectively called the bumps 212 and individually called the bump 212). The bumps 212 are located in the recess 210. A length of the bumps 212 is less than a length of the recess 210, both of which are measured along the length “a” of the glass receptacle 200. Accordingly, front ends of the bumps 212 are recessed from the front surface of the glass receptacle 200. Rear ends of the bumps 212 are flush with a remainder of the upper surface of the glass receptacle 200. The length of the bumps 212 is perpendicular to the width of the recess 210, which is also the width “b” of the glass receptacle 200. The length of the bumps 212 is parallel to the length of the holes 202. The length of the bumps 212 is less than the length of the holes 202.

A height of the bumps 212 (e.g., a radius of the half-rod-like or semi-cylindrical shape of the bumps 212) is equal to the height of the recess 210, both of which are measured along the height “c” of the glass receptacle 200. The bumps 212 are located above the holes 202. A width of the bumps 212 measured along the width “b” of the glass receptacle 200 is less than the diameter of the holes 202. The bumps 212 are also called alignment features of the glass receptacle 200. The bumps 212 are used to passively align a micro-lens array (MLA) to the glass receptacle 200 as described below.

FIG. 3 shows a perspective view of a glass plug 300 that is pluggable into the glass receptacle 200. While various features of the glass plug 300 are described below, the glass plug 300 is a single, unitary machined (tooled) piece of glass. The glass plug 300 is monolithic. The glass plug 300 is solid (not hollow). The glass plug 300 comprises a body 301 and two shafts 302 (shown at 302-1, 302-2) extending from the body 301. The body 301 of the glass plug 300 is generally of the shape of a rectangular cuboid.

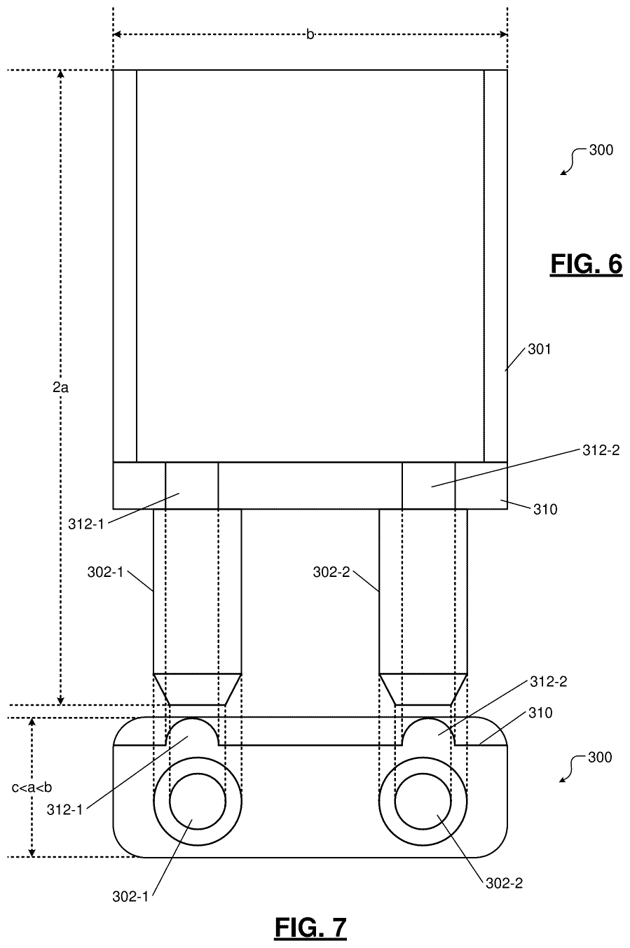

The body 301 of the glass plug 300 has six surfaces: an upper and a lower surface, two sides (side surfaces), and a front and a back surface. The lower surface, the two side surfaces, and the back surface are flat. As shown in FIG. 6, the glass plug 300 has a length “2a,” which is a distance between the back surface of the body 301 and front ends of the shafts 302; a width “b,” which is a distance between the two side surfaces of the body 301; and a height “c,” which is a distance between the lower and the upper surface of the body 301. c<a<b.

The front surface of the body 301 comprises the two shafts 302-1, 302-2 (collectively called the shafts 302 and individually called the shaft 302). The shafts 302 are cylindrical. When the glass plug 300 is plugged into the glass receptacle 200, the shafts 302 insert and slide into the holes 202 of the glass receptacle 200. The shafts 302 extend from the front surface of the body 301. The shafts 302 are cylindrical. The shafts 302 are parallel to each other. The shafts 302 extend parallel to the length “2a” of the glass plug 300.

A length of the shafts 302 is less than the length of the holes 202 in the glass receptacle 200 as seen in FIG. 15. A diameter of the shafts 302 is equal to the diameter of the holes 202 in the glass receptacle 200. A distance between centers of the shafts 302 is equal to a distance between centers of the holes 202 in the glass receptacle 200.

Ends of the shafts 302 that enter into the holes 202 of the glass receptacle 200 are tapered (chamfered). Due to the tapered (chamfered) ends of the shafts 302 and the tapered (chamfered) openings of the holes 202 (described above), the shafts 302 slide and insert smoothly into the holes 202 when the glass plug 300 is plugged into the glass receptacle 200.

While the holes 202 and the shafts 302 are shown and described as being cylindrical, the holes 202 and the shafts 302 can have any other polygonal shape instead. For example, the holes 202 and the shafts 302 can be square, hexagonal, triangular, etc. In general, the holes 202 and the shafts 302 need to have matching geometries (shape and size) and need to be complementary.

The top surface of the body 301 of the glass plug 300 is flat except for a recess and bumps in the recess that are machined (tooled) in the body 301 of the glass plug 300 as described below. The top surface of the body 301 comprises a recess (or a shelf) 310. The recess 310 is generally rectangular. The recess 310 extends between the two side surfaces of the body 301 of the glass plug 300. The recess 310 extends along the length “2a” of the glass plug 300.

The recess 310 extends for a small fraction (e.g., less than one-fifth or one-sixth) of the length of the body 301 measured along the length “2a” of the glass plug 300. A length of the recess 310 measured along the length “2a” of the glass plug 300 is less than the length of the shafts 302. The length of the recess 310 of the glass plug 300 is also less than the length of the recess 210 of the glass receptacle 200.

A width of the recess 310 is equal to the width “b” of the body 301 of the glass plug 300. A height of the recess 310 is a distance between a lower surface of the recess 310 and the upper surface of the body 301 of the glass plug 300. The height of the recess 310 is measured along the height “c” of the body 301 of the glass plug 300.

The top surface of the body 301 of the glass plug 300 comprises two half-rod-like bumps 312-1, 312-2 (collectively called the bumps 312 and individually called the bump 312). The bumps 312 are located in the recess 310. A length of the bumps 312 is equal to a length of the recess 310, both of which are measured along the length “2a” of the glass plug 300. The length of the bumps 312 is perpendicular to the width of the recess 310, which is also the width “b” of the body 301 of the glass plug 300. The length of the bumps 312 is parallel to the length of the shafts 302. The length of the bumps 312 is less than the length of the shafts 302.

Front ends of the bumps 312 are flush (level) with the front surface of the body 301 of the glass plug 300. Rear ends of the bumps 312 are flush with a remainder of the upper surface of the body 301 of the glass plug 300. A height of the bumps 312 (e.g., a radius of the half-rod-like or semi-cylindrical shape of the bumps) is equal to the height of the recess 310, both of which are measured along the height “c” of the body 301 of the glass plug 300. A width of the bumps 312 measured along the width “b” of the body 301 of the glass plug 300 is less than the diameter of the shafts 302. The bumps 312 are also called alignment features of the glass plug 300. The bumps 312 are used to passively align a micro-lens array (MLA) to the glass plug 300 as described below.

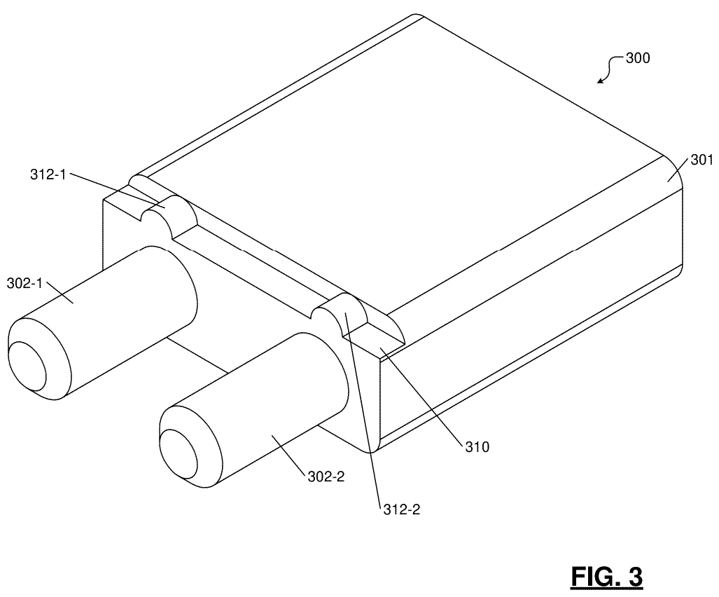

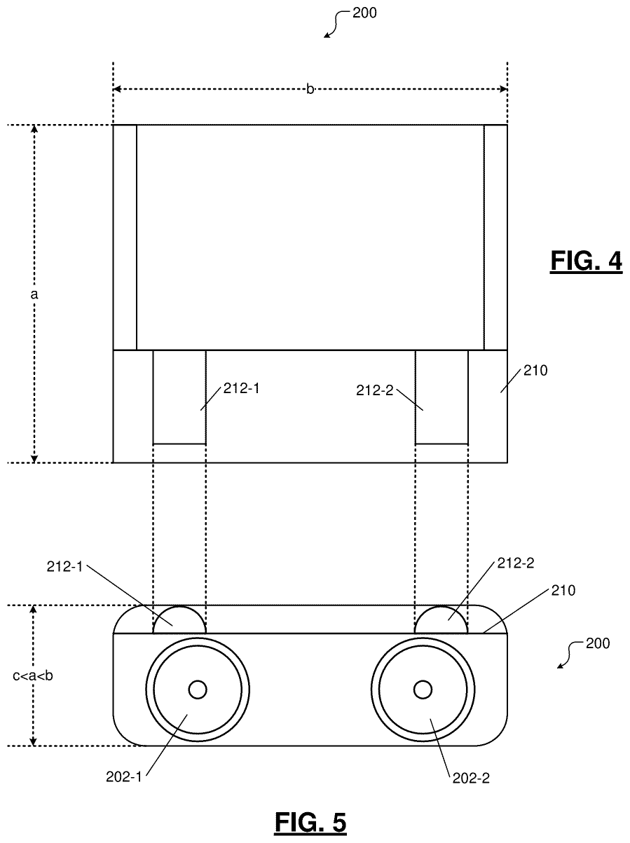

FIGS. 4-7 show additional views of the glass receptacle 200 and the glass plug 300. All elements identified by the same reference numerals as in FIGS. 2 and 3 are not described again for brevity. FIG. 4 shows a top view of the glass receptacle 200. Only the top surface of the glass receptacle 200 comprising the recess 210 and the bumps 212 is visible. The holes 202 are not visible. FIG. 5 shows a front view of the glass receptacle 200. The holes 202 and the bumps 212 in the recess 210 are visible.

FIG. 6 shows a top view of the glass plug 300. The top surface of the body 301 of the glass plug 300 comprising the recess 310 and the bumps 312 is visible. The shafts 302 extending from the body 301 of the glass plug 300 are also visible. FIG. 7 shows a front view of the glass plug 300. The shafts 302 and the bumps 312 in the recess 310 are visible.

### Micro-lens Array

FIGS. 8A-8C show a micro-lens array (MLA) 250 that is attachable to the glass receptacle 200. FIG. 8A shows a front view of the MLA 250. FIG. 8B shows a bottom view of the MLA 250. FIG. 8C shows a side view of the MLA 250.

The MLA 250 comprises a substrate 252 (e.g., made of glass). A plurality of microlenses 254 are mounted on the substrate 252 in a predetermined pattern. The substrate 252 is generally rectangular and has six surfaces: upper and lower surfaces, front and back surfaces, and two sides (side surfaces). The front surface with the microlenses 254 is visible in FIG. 8A. The lower surface with grooves (described below) is visible in FIG. 8B. A side surface (of the two sides) is visible in FIG. 8C.

The MLA 250 has a height “x” measured between the upper and lower surfaces. The MLA 250 has a length “y” measured between the two sides. The MLA 250 has a width or thickness “z” measured between ends of the side surface, which is also a distance between the front and back surfaces. z<x<y.

The MLA 250 comprises two grooves 260-1, 260-2 (collectively called the grooves 260 and individually called the groove 260). The grooves 260 are formed in the lower surface of the substrate 252 that mates with the recess 210 of the glass receptacle 200 as described below. The grooves 260 are triangular. The grooves 260 mate with the bumps 212 in the recess 210 of the glass receptacle 200 when the MLA 250 is arranged in the recess 210 of the glass receptacle 200.

The grooves 260 extend from the lower surface of the substrate 252 into the body of the substrate 252 along the height “x” of the MLA 250. The grooves 260 extend between the front and back surfaces of the substrate 252 along the width or thickness “z” of the substrate 252. A depth of the grooves 260 measured along the height “x” of the MLA 250 is less than half the height “x” of the MLA 250. A length of the groove 260 measured along the width or thickness “z” of the substrate 252 is a distance between ends of the side surface of the substrate 252. The length of the groove 260 measured along the width or thickness “z” of the substrate 252 is also a distance between the front and back surfaces of the substrate 252. The length of the grove 260 is “z.”

An apex 261 of each of the triangular grooves 260 is at a center of each of the triangular grooves 260. The triangle of the grooves 260 is an equilateral triangle or an isosceles triangle. A distance between the apexes 261 of the triangular grooves 260 is equal to a distance between centers of the bumps 212 in the recess 210 of the glass receptacle 200. A width of the grooves 260 “w,” which is a length of a base of the triangle that is opposite to the apex 261, is greater than the width of the bumps 212 in the recess 210 of the glass receptacle 200.

The triangular grooves 260 surround the semi-cylindrical bumps 212 in the recess 210 of the glass receptacle 200 when the MLA 250 is arranged in the recess 210 of the glass receptacle 200. The triangular grooves 260 surrounding the semi-cylindrical bumps 212 ensure perfect alignment of the MLA 250 with the glass receptacle 200. Since the grooves 260 and the bumps 212 are machined (tooled) mechanical elements that provide the alignment without requiring any optical signal or circuitry, the grooves 260 and the bumps 212 are called passive alignment features, and the alignment is called passive alignment.

The front surface of the MLA 250 comprising the microlenses 254 also comprises an identifier 256. The identifier 256 distinguishes the MLA 250 on the side of the glass receptacle 200 from the MLA on the side of the glass plug 300. For example, the identifier 256 can comprise two microlenses on either side of each of the grooves 260 as shown in FIG. 8A. The microlenses in the identifier 256 can be the same as the microlenses 254 but are non-functional (not used for any optical purposes and therefore shown by dotted lines).

Alternatively, the identifier 256 can comprise any sort of marker or markers that can be distinguished by human eye or touch and that is distinct from the identifier on the MLA on the side of the glass plug 300. For example, the identifier 256 can comprise any sort of embossed or engraved marking, a colored marker, or a patterned arrangement of visual and/or tactile elements that is distinct from the identifier on the MLA on the side of the glass plug 300. The distinction and identification provided by the identifier 256 can help in connecting the correct glass plug 300 to the correct glass receptacle 200 during assembly, testing, installation, and/or service operations.

FIGS. 9A-9C show a micro-lens array (MLA) 350 that is attachable to the glass plug 300. FIG. 9A shows a front view of the MLA 350. FIG. 9B shows a bottom view of the MLA 350. FIG. 9C shows a side view of the MLA 350. The MLA 350 comprises the substrate 252 (e.g., glass) on which the plurality of microlenses 254 are mounted in the same pattern as that used in the MLA 250. The MLA 350 comprises the grooves 260. The MLA 350 is identical to the MLA 250 except for an identifier 356. The identifier 356 of the MLA 350 is distinct compared to the identifier 256 of the MLA 250.

For example, the identifier 356 can comprise four microlenses arranged between the grooves 260 as shown in FIG. 9A. The microlenses in the identifier 356 can be the same as the microlenses 254 but are non-functional (not used for any optical purposes and therefore shown by dotted lines). Alternatively, the identifier 356 can comprise any sort of marker or markers that can be distinguished by human eye or touch and that is distinct from the identifier 256 on the MLA 250 on the side of the glass receptacle 200. For example, the identifier 356 can comprise any sort of embossed or engraved marking, a colored marker, or a pattern of visual and/or tactile elements that is distinct from the identifier 256. The distinction and identification provided by the identifiers 256, 356 can help in connecting the correct glass plug 300 to the correct glass receptacle 200 during assembly, testing, installation, and/or service operations.

In FIGS. 9A-9C, all elements identified by the same reference numerals as in FIGS. 8A-8C are not described again for brevity. The following description is added for completeness and clarity. In the MLA 350, the grooves 260 mate with the bumps 312 in the recess 310 of the glass plug 300 when the MLA 350 is arranged on the bumps 312 in the recess 310 of the glass plug 300. A distance between the apexes of the triangular grooves 260 is equal to a distance between centers of the bumps 312 in the recess 310 of the glass plug 300. A width of the grooves 260 “w,” which is a length of a base of the triangle that is opposite to the apex 261, is greater than the width of the bumps 312 in the recess 310 of the glass plug 300.

The triangular grooves 260 surround the semi-cylindrical bumps 312 in the recess 310 of the glass plug 300 when the MLA 350 is arranged in the recess 310 of the glass plug 300. The triangular grooves 260 surrounding the semi-cylindrical bumps 312 ensure perfect alignment of the MLA 350 with the glass plug 300. Since the grooves 260 and the bumps 312 are machined (tooled) mechanical elements that provide the alignment without requiring any optical signal or circuitry, the grooves 260 and the bumps 312 are called passive alignment features, and the alignment is called passive alignment.

While the bumps 212, 312 are shown and described as having semi-cylindrical shape and the grooves 260 are shown and described as having triangular shape, these shapes are non-limiting examples and can be varied. For example, the bumps 212, 312 and the grooves 260 can be triangular. The bumps 212, 312 and the grooves 260 can be rectangular. The bumps 212, 312 and the grooves 260 can be semi-cylindrical. The bumps 212, 312 can be rectangular, and the grooves 260 can be semi-cylindrical or triangular. The bumps 212, 312 can be semi-cylindrical, and the grooves 260 can be rectangular. Many other shapes and combinations of shapes can be used. Further, the bumps 212 can have a first shape, and the bumps 312 can have a second shape that is different than the first shape. The grooves 260 of the MLA 250 can have a first shape, and the grooves 260 of the MLA 350 can have a second shape that is different than the first shape.

Furthermore, while two holes 202 and two shafts 302 are shown and described, an additional third hole and an additional third shaft can be provided between the two holes 202 and two shafts 302 to improve stability and alignment of connection between the glass receptacle 200 and the glass plug 300. The third hole and the third shaft can be identical to the two holes 202 and two shafts 302 or can be smaller than the two holes 202 and two shafts 302. The third hole and the third shaft can provide redundancy if one of the two holes 202 and/or one of the two shafts 302 break. The third hole and the third shaft can also be keyed (shaped) such that the glass plug 300 can be inserted into the glass receptacle 200 in only one position and cannot be inserted in any other position.

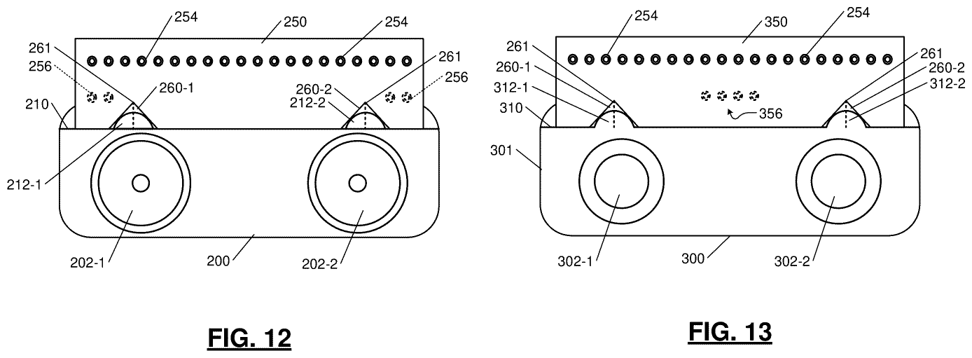

FIGS. 10-13 show mounting of the MLAs 250, 350 on the glass receptacle 200 and the glass plug 300, respectively, and show alignment between respective alignment features. All views are front views. FIG. 10 shows the MLA 250 and the glass receptacle 200. FIG. 11 shows the MLA 350 and the glass plug 300. FIG. 12 shows the MLA 250 aligned with and mounted to the glass receptacle 200. FIG. 13 shows the MLA 350 aligned with and mounted to the glass plug 300. All elements identified by the same reference numerals as in FIGS. 2-9C are not described again for brevity.

### Detachable Connector System

FIG. 14 shows the glass plug 300 plugged into the glass receptacle 200. All elements identified by the same reference numerals as in FIGS. 2-13 are not described again for brevity. The MLAs 250, 350 are mounted on and aligned with the glass receptacle 200 and the glass plug 300, respectively. The MLAs 250, 350 are aligned automatically upon mounting on the glass receptacle 200 and the glass plug 300 due to the tooled mechanical alignment features (the grooves 260 of the MLAs 250, 350 and the bumps 212, 312 of the glass receptacle 200 and the glass plug 300). No alignment procedure is required. The shafts 302 of the glass plug 300 are aligned with and inserted into the holes 202 in the glass receptacle 200. The microlenses 254 of the MLAs 250, 350 are perfectly aligned with each other.

The machined (tooled) mechanical alignment features such as the bumps 212, 312 of the glass receptacle 200 and the glass plug 300; the grooves 260 on the MLAs 250, 350; and the shafts 302 and the holes 202 of the glass receptacle 200 and the glass plug 300 automatically (simply by virtue of these alignment features engaging with each other as described above) align the microlenses 254 of the MLAs 250, 350 with each other. No optical signals, circuitry, or any other alignment device is used to align the microlenses 254 of the MLAs 250, 350 with each other. Accordingly, the alignment features of the glass receptacle 200 and the glass plug 300 and of the MLAs 250, 350 are called passive alignment features. The alignment of the microlenses 254 of the MLAs 250, 350 provided by the passive alignment features of the glass receptacle 200 and the glass plug 300 and of the MLAs 250, 350 is called passive alignment.

FIG. 15 shows a cross-sectional view of a complete assembly of the detachable connect system comprising the glass receptacle 200 and the glass plug 300. All elements identified by the same reference numerals as in FIGS. 2-14 are not described again for brevity.

The MLAs 250, 350 are mounted to the glass receptacle 200 and the glass plug 300 as shown in FIG. 14. The optical fiber array unit (FAU) 360 is attached to a support 361. The FAU 360 is attached to the glass plug 300. The PIC 100 is soldered to a substrate (e.g., a PCB) 101. The PIC 100 is attached to the glass receptacle 200. The glass plug 300 with attached MLA 350 and FAU 360 is plugged into the glass receptacle 200 with attached MLA 250 and PIC 100. The microlenses 254 of the MLAs 250, 350 are perfectly aligned with each other. The optical fibers 370 (shown in FIGS. 16A and 16B) of the FAU 360 are perfectly aligned with the microlenses 254 of the MLA 350.

The PIC 100 is attached (e.g., glued using epoxy) to the glass receptacle 200 as shown at 290. The support 361 is attached (e.g., glued using epoxy) to the body 301 of the glass plug 300 as shown at 292. The MLAs 250, 350 are attached (e.g., glued using epoxy) to the glass receptacle 200 and to the body 301 of the glass plug 300, respectively, as shown at 294, 296.

In use, optical signals are transmitted from the PIC 100 through the microlenses 254 of the MLA 250, through the microlenses 254 of the MLA 350, and through the optical fibers 370 of the FAU 360. Optical singles received through the optical fibers 370 of the FAU 360 are transmitted through the microlenses 254 of the MLA 350, and through the microlenses 254 of the MLA 250 to the PIC 100. In some examples, gaps between the MLAs 250, 350 and the PIC 100 and the FAU 360 may be filled as shown at 293 with a material having optical properties (e.g., refractive index) that does not distort the optical signals.

FIGS. 16A and 16B show the optical fiber array unit (FAU) 360. The FAU 360 comprises a plurality of optical fibers 370. FIG. 16A shows a front view of the FAU 360 showing the optical fibers 370 of the FAU 360. FIG. 16B shows a side view of the FAU 360. In FIG. 15, the optical fibers 370 of the FAU 360 are aligned with the microlenses 254 of the MLA 350.

### Active Alignment

FIG. 17A shows the MLA 250 and the glass receptacle 200 where the MLA 250 can be passively aligned and mounted to the glass receptacle 200 using respective alignment features (the bumps 212 and the grooves 260) as described above. All elements identified by the same reference numerals as in FIGS. 2-14 are not described again for brevity.

FIG. 17B shows the glass plug 300 and an MLA 351 without the grooves 260 of the MLA 350. All elements identified by the same reference numerals as in FIGS. 2-14 are not described again for brevity. The MLA 351 is identical to the MLA 350 except that the MLA 351 does not comprise the grooves 260. The lower surface of the MLA 351 that mates with the body 301 of the glass plug 300 is flat. Since the MLA 351 does not comprise the grooves 260, the bumps 312 of the glass plug 300 are immaterial (i.e., can be present or absent). The body 301 of the glass plug 300 can comprise the bumps 312, which are not used for aligning the MLA 351. Alternatively, the bumps 312 (but not the recess 310) can be omitted in the glass plug 300. The MLA 351 can be aligned and mounted to the glass plug 300 using active alignment (e.g., using a mirror) as described below in detail.

While not shown, the active alignment can also be used on the side of the glass receptacle 200. For example, an MLA 251 similar to the MLA 351 (except for the distinct identifier as described above) can be used instead of the MLA 250. In other examples, active alignment can be employed on the sides of both the glass receptacle 200 and the glass plug 300. The passive and active alignments can be used in any combination on the sides of both the glass receptacle 200 and the glass plug 300.

FIG. 18 shows a cross-sectional view of a complete assembly of the detachable connect system comprising the glass receptacle 200 and the glass plug 300. All elements identified by the same reference numerals as in FIGS. 2-17B are not described again for brevity. The description of FIG. 18 is similar to the description of FIG. 15 except for the following differences.

The MLA 351 is not attached to the body 301 of the glass plug 300. Instead, the MLA 351 is attached (e.g., glued using epoxy) to the support 361 of the optical fiber array unit (FAU) 360 as shown at 297. The microlenses 254 of the MLAs 250, 351 are perfectly aligned with each other. The optical fibers 370 (shown in FIGS. 16A and 16B) of the FAU 360 are perfectly aligned with the microlenses 254 of the MLA 351.

In use, optical signals are transmitted from the PIC 100 through the microlenses 254 of the MLA 250, through the microlenses 254 of the MLA 351, and through the optical fibers 370 of the FAU 360. Optical singles received through the optical fibers 370 of the FAU 360 are transmitted through the microlenses 254 of the MLA 351, and through the microlenses 254 of the MLA 250 to the PIC 100. In some examples, the gap between the MLA 250 and the PIC 100 may be filled with a material having optical properties (e.g., refractive index) that does not distort the optical signals.

The MLA 351 can be aligned and mounted to the glass plug 300 using active alignment (e.g., using a mirror) as follows. Initially, the MLA 351 is aligned to the FAU 360 by placing a mirror (not shown) in front of the MLA 351. Light transmitted through the FAU 360 passes through the MLA 351 and is incident on the mirror. The light reflected from the mirror passes through the MLA 351 to the FAU 360. By detecting the reflected light received through the FAU 360 and by adjusting relative positions of the MLA 351 and the FAU 360 relative to each other, the MLA 351 and the FAU 360 can be aligned with each other.

Upon alignment, the MLA 351 is attached (e.g., glued) to the FAU 360. Subsequently, the glass plug 300 is inserted into the glass receptable 200. The FAU 360, with the MLA 351 attached thereto, is aligned with the MLA 250 that is already attached to the glass receptacle 200. Upon alignment of the MLAs 250 and 351, the FAU 360 with the MLA 351 attached thereto is attached (e.g., glued) to the glass plug 300.

Finally, the PIC 100 is aligned with the assembly comprising the glass plug 300 and the glass receptacle 200 with respective MLAs 250, 351. Upon alignment, the PIC 100 is attached (e.g., glued) to the glass receptacle 200. Thereafter, the glass plug 300 and FAU sub-assembly 360 is disconnected (removed, detached, or disengaged) from the glass receptacle 200.

The detachable optical connector system shown in FIGS. 15 and 18 provides high-density optical interconnect with minimal loss. The detachable connector system of FIG. 15 eliminates the need for active alignment. However, a combination of passive and active alignment can be used as described above with reference to FIG. 18. The detachable connector system shown in FIGS. 15 and 18 also provides flexibility in attaching the PIC subassembly 100 to an optical module/switch by using reliable solder reflow as follows.

In the detachable connector system shown in FIGS. 15 and 18, the PIC 100 is attached to the glass receptacle 200 with the MLA 250 as described above. The FAU 360 is attached to the glass plug 300 instead of the PIC 100. Then, with no FAU attached to the PIC, the PIC 100 and the glass receptacle 200 with the MLA 250 are soldered to the substrate 101. Unlike the FAU 360, the glass receptacle 200 and the MLA 250 can withstand the solder reflow. After the soldering, the glass plug 300 with attached FAU 360 and MLA 350 (or 351) can be attached to (plugged into) the glass receptable 200 with attached MLA 250 and the PIC 100. Thus, in the detachable connector system shown in FIGS. 15 and 18, the FAU 360 need not be attached to the PIC 100 and need not undergo the soldering process. Absence of fiber ribbon appendages (the FAU 360) during optical module/switch attachment (reflow soldering) significantly improves yield.

The detachable optical connector system shown in FIGS. 15 and 18 also allows modular testing of each PIC subassembly and other components such as light engines before attaching the components to an optical module/switch. For example, a light engine can be attached (e.g., glued) to the glass receptacle 200 with the MLA 250. The light engine attached to the glass receptable 200 can then be soldered onto a substrate and tested. The glass plug 300 with attached FAU 360 and MLA 350 (or 351) can be inserted into the glass receptacle 200 if and as needed. After thus testing multiple light engines, the light engines can be assembled into an optical module/switch.

Throughout the present disclosure, various components are attached to each other using an epoxy as glue. However, epoxy glue is a non-limiting example. Alternatively, the components can be attached using other suitable means so long as the other suitable means can achieve the high precision alignment and robust handling requirements for the connector assemblies described herein.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

In this application, electronic components such as transmitter, receiver, and so on may be replaced by respective circuits (e.g., transmitter circuit, receiver circuit, etc.). The terms transmitter, receiver, etc. may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit that executes code; a memory circuit that stores code executed by the processor circuit; other suitable hardware components that provide the described functionality; or a combination of some or all of the above, such as in a system-on-chip.

What is claimed is:

1. A detachable connector system for optical communication comprising:
a connector comprising first alignment features; and
a micro-lens array arranged on the connector, the micro-lens array comprising second alignment features that are complementary to the first alignment features.

2. The system of claim 1 wherein the connector is made of glass.

3. The system of claim 1 wherein the connector is monolithic.

4. The system of claim 1 wherein:
the first alignment features have a semi-cylindrical shape; and
the second alignment features comprise grooves.

5. The system of claim 4 wherein the grooves are triangular and surround the first alignment features.

6. The system of claim 1 wherein:
the connector has a shape of a rectangular cuboid; and
the connector comprises two holes that extend along a length of the connector.

7. The system of claim 6 wherein:
an upper surface of the connector comprises a recess;
the first alignment features are arranged on the recess; and
the first alignment features extend along the length of the connector.

8. The system of claim 1 wherein:
the connector comprises a body having a shape of a rectangular cuboid; and
the connector comprises two shafts that extend from the body along a length of the connector.

9. The system of claim 8 wherein:
an upper surface of the body comprises a recess;
the first alignment features are arranged on the recess; and
the first alignment features extend along the length of the connector.

10. A detachable connector system for optical communication comprising:
a first connector comprising holes and first alignment features;
a first micro-lens array arranged on the first connector, the first micro-lens array comprising second alignment features that are complementary to the first alignment features;
a second connector comprising shafts configured to insert into the holes; and
a second micro-lens array arranged on the second connector.

11. The system of claim 10 wherein the first and second connectors are made of glass.

12. The system of claim 10 wherein the first and second connectors are monolithic.

13. The system of claim 10 wherein:
the second connector comprises third alignment features; and
the second micro-lens array comprises fourth alignment features that are complementary to the third alignment features.

14. The system of claim 13 wherein the second micro-lens array is aligned with the first micro-lens array by the first through fourth alignment features.

15. The system of claim 13 wherein:
the first and third alignment features have a semi-cylindrical shape; and
the second and fourth alignment features comprise grooves.

16. The system of claim 15 wherein:
the grooves are triangular;
the grooves of the first micro-lens array surround the first alignment features of the first connector; and
the grooves of the second micro-lens array surround the third alignment features of the second connector.

17. The system of claim 13 wherein:
the first and second connectors have a shape of a rectangular cuboid;
the holes extend along a length of the first connector; and
the shafts extend along a length of the second connector.

18. The system of claim 17 wherein:
an upper surface of the first connector comprises a first recess;
the first alignment features are arranged on the first recess along the length of the first connector;
an upper surface of the second connector comprises a second recess; and
the third alignment features are arranged on the second recess along the length of the second connector.

19. The system of claim 14 further comprising:
a silicon photonics integrated circuit attached to the first connector; and
an optical fiber array unit attached to the second connector.

20. A detachable connector system for optical communication comprising:
a first connector comprising holes and first alignment features;
a first micro-lens array arranged on the first connector, the first micro-lens array comprising second alignment features that mate with the first alignment features;
a silicon photonics integrated circuit attached to the first connector;
a second connector comprising shafts configured to insert into the holes and comprises third alignment features;
a second micro-lens array arranged on the second connector, the second micro-lens array comprising fourth alignment features that mate with the third alignment features; and
an optical fiber array unit attached to the second connector.

21. The system of claim 20 wherein the first and second connectors are made of glass and are monolithic.

22. The system of claim 20 wherein the second micro-lens array is aligned with the first micro-lens array by the first through fourth alignment features.

23. The system of claim 20 wherein:
the first and third alignment features have a semi-cylindrical shape; and
the second and fourth alignment features comprise grooves.

24. The system of claim 23 wherein:
the grooves are triangular;
the grooves of the first micro-lens array surround the first alignment features of the first connector; and
the grooves of the second micro-lens array surround the third alignment features of the second connector.

25. The system of claim 20 wherein:
the first and second connectors have a shape of a rectangular cuboid;
the holes extend along a length of the first connector; and
the shafts extend along a length of the second connector.

26. The system of claim 25 wherein:
an upper surface of the first connector comprises a first recess;
the first alignment features are arranged on the first recess along the length of the first connector;
an upper surface of the second connector comprises a second recess; and
the third alignment features are arranged on the second recess along the length of the second connector.
